(19) United States
(12) Patent Application Publication
(10) Pub. No.: US 2018/0107543 A1
(43) Pub. Date: Apr. 19, 2018

(54) PARTIAL RESPONSE PROCESSING FOR IMPROVED PERFORMANCE AND DECISION MAKING

(71) Applicant: International Business Machines Corporation, Armonk, NY (US)

(72) Inventors: Andrew D. Baptist, Mt. Pleasant, WI (US); Greg R. Dhuse, Chicago, IL (US); Ravi V. Khadiwala, Bartlett, IL (US); Jason K. Resch, Chicago, IL (US); Wesley B. Leggette, Chicago, IL (US); Trevor J. Vossberg, Chicago, IL (US); S. Christopher Gladwin, Chicago, IL (US)

(21) Appl. No.: 15/843,220

(22) Filed: Dec. 15, 2017

Related U.S. Application Data
(63) Continuation-in-part of application No. 15/671,746, filed on Aug. 8, 2017.
Application No. 15/671,746 is a continuation-in-part of application No. 14/955,200, filed on Dec. 1, 2015, now Pat. No. 9,740,547.
(60) Provisional application No. 62/109,700, filed on Jan. 30, 2015.

(51) Int. Cl. G06F 11/10; G06F 3/06

(52) U.S. Cl. CPC G06F 11/1076; G06F 3/067; G06F 3/064; G06F 3/0619

(57) ABSTRACT

A method begins by sending a set of read requests to a set of storage units of a dispersed storage network regarding a set of encoded data slices (EDSs). The method continues by receiving read responses from at least some storage units of the set of storage units, where at least one read response includes two EDSs. As read responses are being received and prior to receiving the read responses completely, the method continues by determining whether a decode threshold number of read responses have been received. When the threshold number of read responses have been received, the method continues by determining whether a first EDS position of each of the decode threshold number of read responses includes EDSs having different pillar numbers. When the read responses include the EDSs having different pillar numbers, the method continues by decoding the EDSs to recapture a data segment of a data object.

### CROSS-REFERENCE TO RELATED APPLICATIONS

The present U.S. Utility Patent Application claims priority pursuant to 35 U.S.C. § 120 as a continuation-in-part of U.S. Utility application Ser. No. 15/671,746, entitled “STORING AND RETRIEVING DATA USING PROXIES”, filed Aug. 8, 2017, which is a continuation-in-part of U.S. Utility application Ser. No. 14/955,200, entitled “STORING DATA USING A DUAL PATH STORAGE APPROACH”, filed Dec. 1, 2015, now issued as U.S. Pat. No. 9,740,547 on 8/22/2017, which claims priority pursuant to 35 U.S.C. § 119(e) to U.S. Provisional Application No. 62/109,700, entitled “REDUNDANTLY STORING DATA IN A DISPERSED STORAGE NETWORK”, filed Jan. 30, 2015, now expired, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to computer networks and more particularly to dispersed storage error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9A is a schematic block diagram of another embodiment of a dispersed storage network (DSN) in accordance with the present invention;

FIG. 9B is a schematic block diagram of another embodiment of a dispersed storage network (DSN) in accordance with the present invention;

FIG. 10 is a flowchart illustrating an example of recovering data in accordance with the present invention;

FIG. 11A is a schematic block diagram of partial response decoding in accordance with the present invention;

FIG. 11B is a schematic block diagram of another partial response decoding in accordance with the present invention; and

FIG. 12 is a flowchart illustrating an example of a method of partial response decoding in accordance with the present invention.

### DETAILED DESCRIPTION OF THE INVENTION

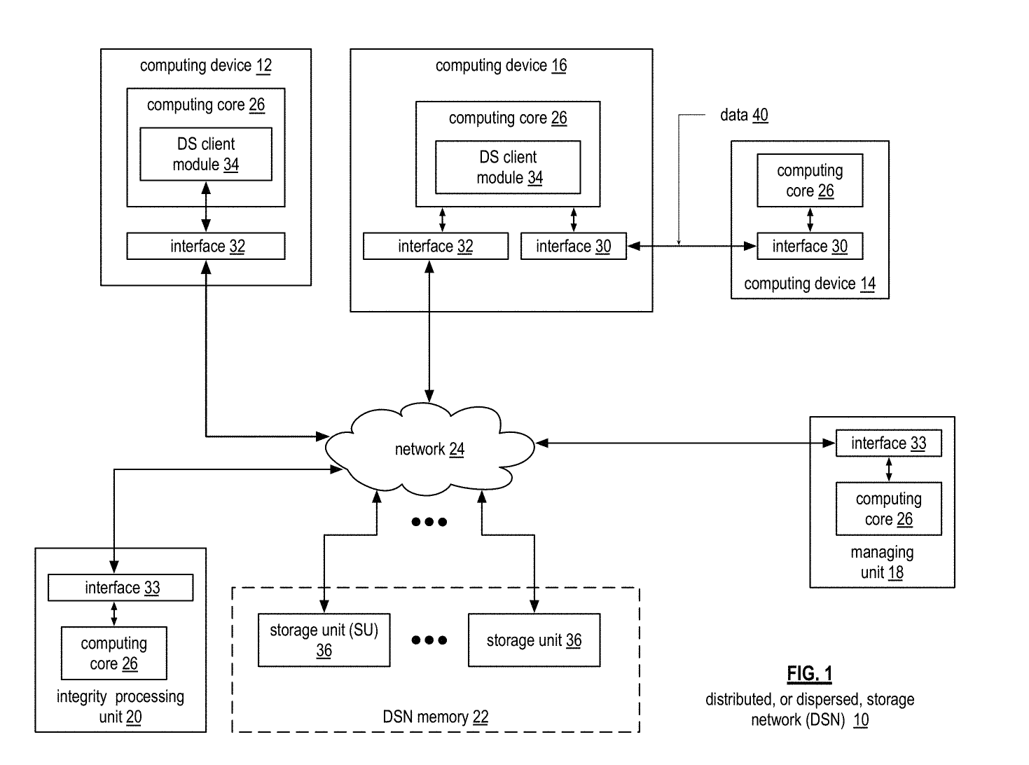

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

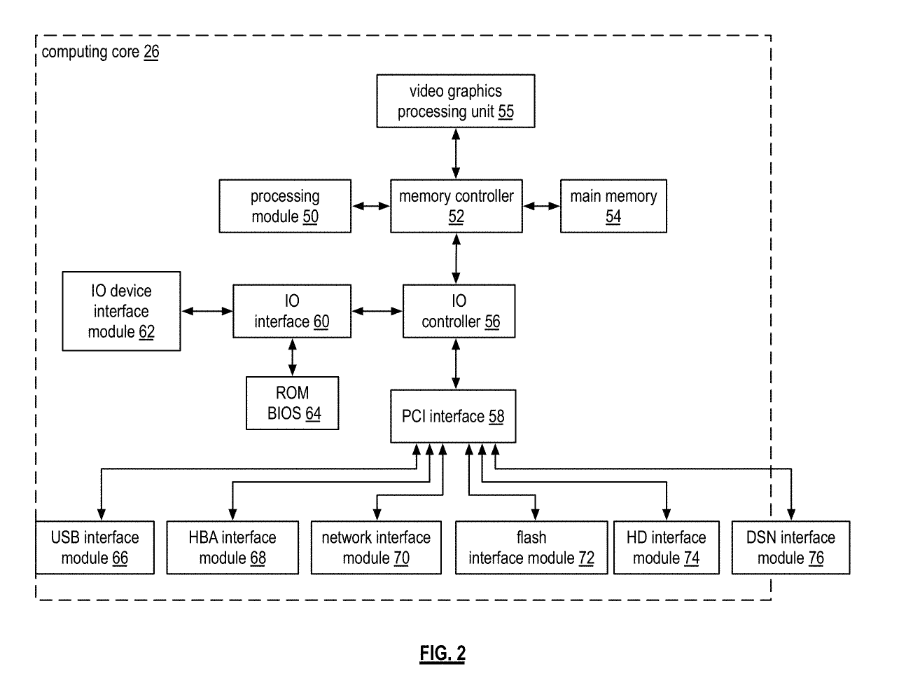

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

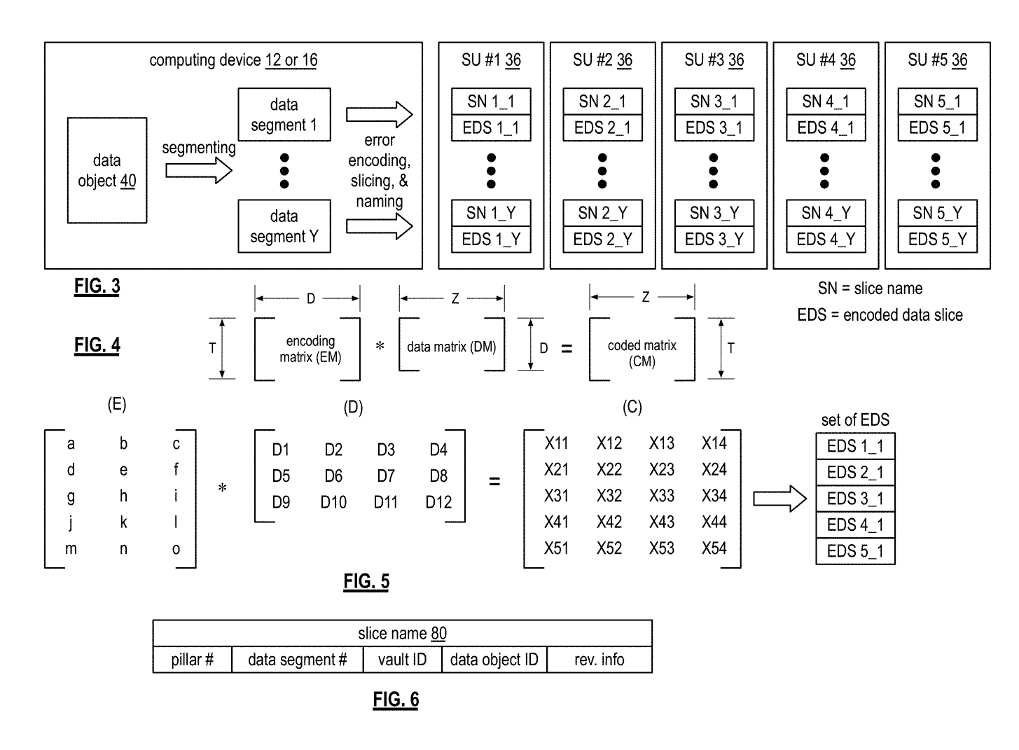

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data (e.g., data 40) on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (10) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the 10 device interface module 62 and/or the memory interface modules 66-76 may be collectively or individually referred to as 10 ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R)of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

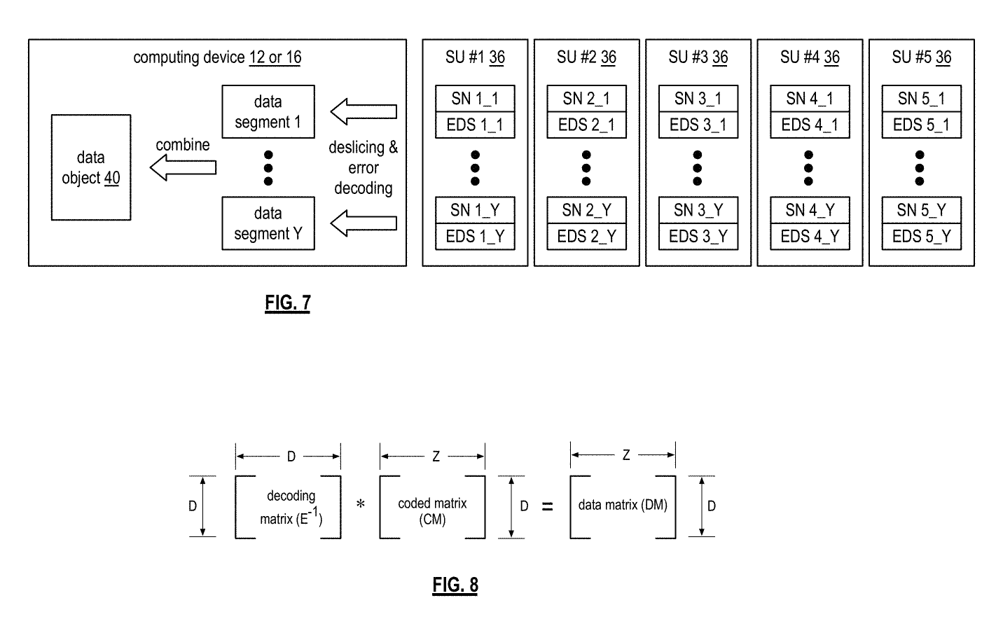

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

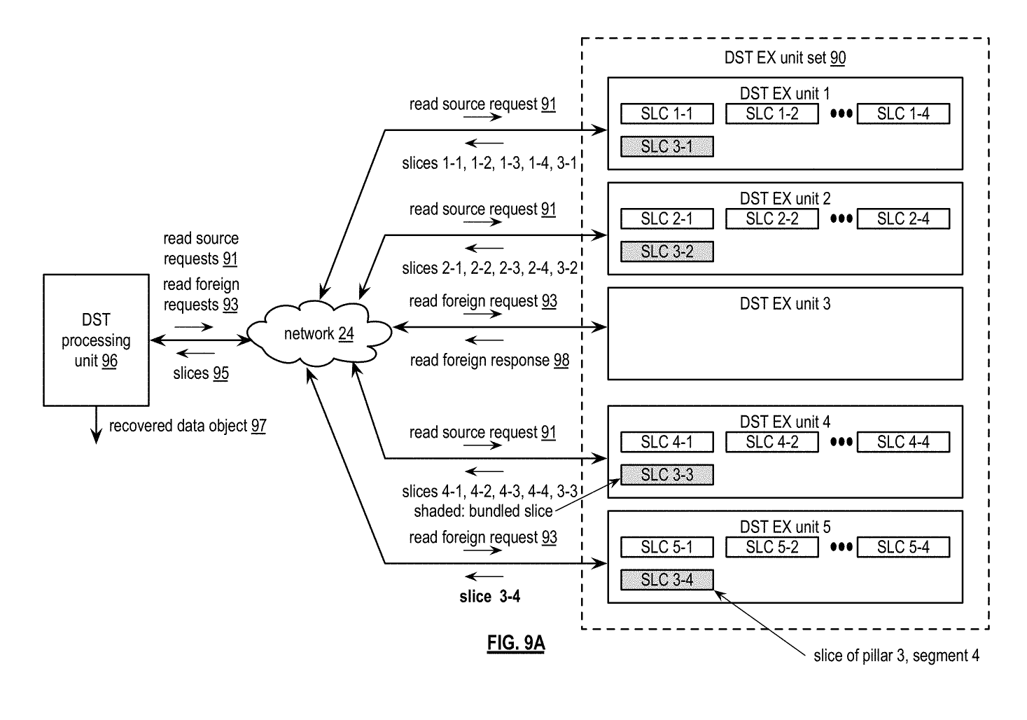

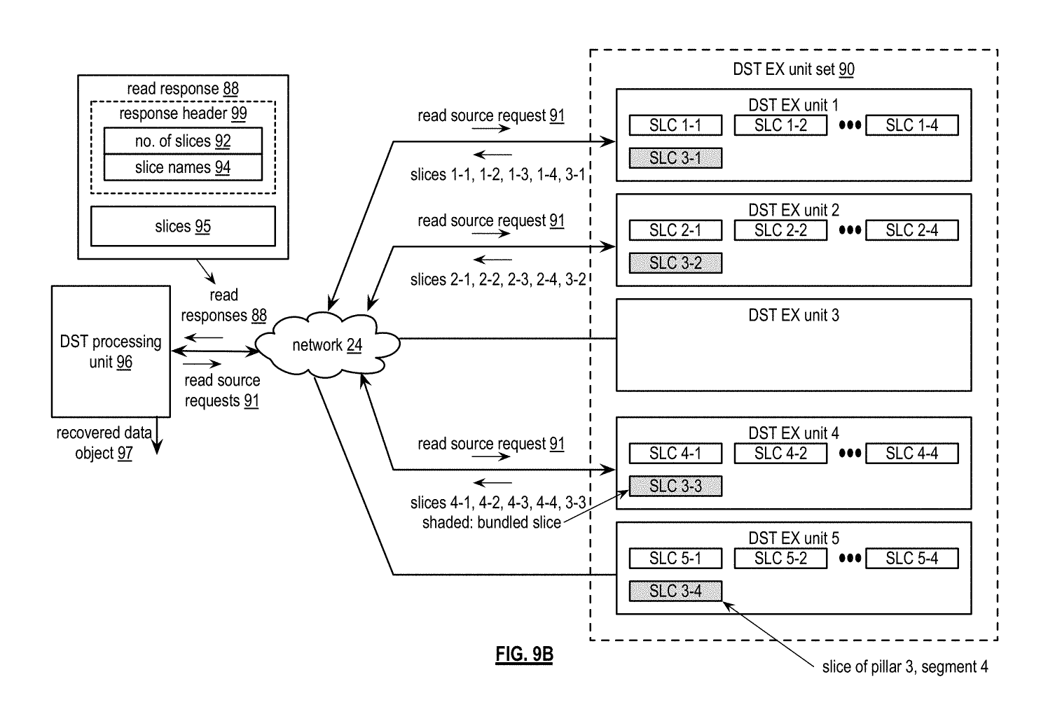

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

FIG. 9A is a schematic block diagram of another embodiment of a dispersed storage network (DSN) that includes a distributed storage and task (DST) processing unit 96, the network 24 of FIG. 1, and a DST execution (EX) unit set 90. Each DST EX unit of the DST EX unit set may be implemented by a storage unit 36 of FIG. 1 that includes the computing core 26 of FIG. 1. The DST processing unit 96 may be implemented by a computing device 12-16 of FIG. 1. Each DST execution unit is affiliated with a unique encoded data slice of a set of encoded data slices for storage where data is dispersed storage error encoded in accordance with dispersal parameters to produce a plurality of sets of encoded data slices. For example, the DST execution unit set includes DST execution units 1-5 when the dispersal parameters includes an information dispersal algorithm (IDA) width of n=5. The DSN functions to recover data that has been stored in the DST execution unit set.

In an example of operation of the recovering of the data, the DST processing unit 96 identifies a stored data object for retrieval from the DST execution unit set to produce a data identifier (ID), where the data object is dispersed storage error encoded to produce a plurality of sets of encoded data slices and where the plurality of sets of encoded data slices are stored in the DST execution unit set. Each encoded data slice is associated with a unique slice name and each slice name includes a common source name. The identifying includes at least one of interpreting a request and performing a lookup.

Having identified the stored data object for retrieval, the DST processing unit 96 determines a DSN address that corresponds to the stored data object. The DSN address includes a virtual address associated with the storage of the store data object. The virtual address includes a common source name. As an example of the determining of the DSN address, the DST processing unit 96 interprets an entry of a dispersed hierarchical index based on the data ID to identify the common source name. As another example of the determining of the DSN address, the DST processing unit 96 interprets a DSN directory based on the data ID to identify the common source name.

Having determined the DSN address, the DST processing unit 96 generates a read source request 91 based on the DSN address. For example, the DST processing unit 96 populates a source name field of the read source request with the identified common source name. Having generated the read source request 91, the DST processing unit 96 selects a subset of DST execution units of the DST execution unit set for the read source request. The selecting includes one or more of interpreting a DSN address to physical location table and interpreting DST execution unit status to identify a decode threshold number of DST execution units that are most likely to include a desired encoded data slices. For example, the DST processing unit 96 identifies DST execution units 1, 2 and 4 when a status for DST execution unit 3 indicates recent unavailability and DST execution units 1, 2, and 4 should include a decode threshold number of encoded data slices for each set of encoded data slices in accordance with a previous storage operation.

Having selected the subset of DST execution units, the DST processing unit 96 sends the read source request to the selected subset of DST execution units. For example, the DST processing unit 96 sends the read source request 91 for particular encoded data slices (e.g., encoded data slices that include a source name and a particular pillar number) to targeted DST execution units 1, 2, and 4. Having sent the read source request 91, the DST processing unit 96 sends a read foreign slices read source request 93 (e.g., read foreign request) to remaining DST execution units of the set of DST execution units.

Each read foreign slice read source request 93 includes an indicator to instruct the receiving DST execution unit to return encoded data slices foreign to the DST execution unit (e.g., bundled encoded data slices that are affiliated with at least one other DST execution unit). For example, the DST processing unit 96 sends the read foreign slice read source request 93 to remaining DST execution units 3 and 5.

Having sent the read foreign slice read source requests 93, the DST processing unit 96 receives retrieved encoded data slices 95 (e.g., in the read foreign response 98, etc.) from at least some of the DST execution units of the set of DST execution units. For example, the DST processing unit 96 receives bundled encoded data slice 3-4 from DST execution unit 5, receives encoded data slices 4-1 through 4-4 and bundled encoded data slice 3-3 from DST execution unit 4, no foreign slices from DST execution unit 3, encoded data slices 2-1 through 2-4 and bundled encoded data slice 3-2 from DST execution unit 2, and encoded data slices 1-1 through 1-4, and bundled encoded data slice 3-1 from DST execution unit 1. As such, the DST processing unit 96 receives, for each set of encoded data slices, a decode threshold number of total encoded data slices.

Having received the retrieved encoded data slices 95, for each set of encoded data slices, the DST processing unit 96 dispersed storage error decodes the decode threshold number of encoded data slices to reproduce a data segment corresponding to the set of encoded data slices. Having reproduced a plurality of data segments (e.g., 4 data segments), the DST processing unit aggregates the plurality of reproduced data segments to produce a recovered data object 97.

FIG. 9B is a schematic block diagram of another embodiment of a dispersed storage network (DSN) that includes the distributed storage and task (DST) processing unit 96 of FIG. 9A, the network 24 of FIG. 1, and the DST execution (EX) unit set 90 of FIG. 9A. The DST execution unit set includes a set of DST execution units, where each DST execution unit is affiliated with a unique encoded data slice of a set of encoded data slices for storage and where data is dispersed storage error encoded in accordance with dispersal parameters to produce a plurality of sets of encoded data slices. For example, the DST execution unit set includes DST execution units 1-5 when the dispersal parameters include an information dispersal algorithm (IDA) width of n=5. The DSN functions to recover data that has been stored in the DST execution unit set.

In an example of operation of the recovering of the data, the DST processing unit 96 identifies a stored data object for retrieval from the DST execution unit set 90 to produce a data identifier (ID), where the data object is dispersed storage error encoded to produce a plurality of sets of encoded data slices and where the plurality of sets of encoded data slices are stored in the DST execution unit set. Each encoded data slice is associated with a unique slice name 94 and each slice name includes a common source name. The source name includes one or more of a vault identifier, a data object identifier, a generation level, and a revision level. The identifying includes at least one of interpreting a request and performing a lookup.

Having identified the stored data object for retrieval, the DST processing unit 96 determines a DSN address that corresponds to the stored data object. The DSN address includes a virtual address associated with the storage of the store data object. The virtual address includes a common source name. As an example of the determining of the DSN address, the DST processing unit 96 interprets an entry of a dispersed hierarchical index based on the data ID to identify the common source name. As another example of the determining of the DSN address, the DST processing unit 96 interprets a DSN directory based on the data ID to identify the common source name.

Having determined the DSN address, the DST processing unit 96 identifies a first subset of DST execution units of the DST execution unit set where an estimated decode threshold number of encoded data slices of each set of encoded data slices is stored. The identifying includes at least one of performing a lookup, interpreting storage unit status, issuing list slice requests, and interpreting received list slice responses. For example, the DST processing unit 96 identifies DST execution units 1, 2, and 4 to include storage of the estimated decode threshold number of encoded data slices of each set of encoded data slices.

Having identified the first subset of DST execution units, the DST processing unit 96 issues one or more of a read source request 91 and a read foreign slice read source request 93 to the identified subset of DST execution units. The issuing includes generating the source requests and sending, via the network 24, the source requests to the identified subset of DST execution units. For example, the DST processing unit 96 issues a read source request 91 to the DST execution units 1, 2, and 4.

Having issued the read source requests 91, the DST processing unit 96 initiates receiving, via the network 24, one or more read responses 88 from the first subset of DST execution units. Each read response 88 includes a response header 99 and one or more encoded data slices 95. The response header 99 includes one or more of a number of slices field 92 and a slice names field 94 corresponding to the one or more encoded data slices 95. For example, the DST processing unit 96 begins to receive a read response 88 from DST execution unit 1 where the response header 99 of the read response 88 indicates that the read response 88 includes five encoded data slices and the slice names correspond to encoded data slices 1-1 through 1-4 and bundled encoded data slice 3-1. As a continuation of the example, the DST processing unit 96 receives response headers 99 of read responses 88 from the DST execution unit 2 and the DST execution unit 4.

Having initiated receiving of the read responses 88, where response headers 99 have been interpreted, the DST processing unit 96 determines a likelihood level of receiving the decode threshold number of encoded data slices for each of the sets of encoded data slices when remaining portions of the read responses 88 are received in a streaming fashion via the network 24. The interpreting includes interpreting each response header 99 of each read response 88 to estimate which encoded data slices are likely to be received when the read response streams have been completely ingested by the DST processing unit 96. For example, the DST processing unit 96 indicates a high likelihood level when estimating that the decode threshold number of encoded data slices for each set of encoded data slices should be received in accordance with slice names 94 of the response headers 99.

When the likelihood level is greater than a high likelihood threshold level, the DST processing unit 96 completes the receiving of the read responses 88 to produce the decode threshold number of encoded data slices for each of the sets of encoded data slices. When the likelihood level is less than a low likelihood threshold level, the DST processing unit 96 obtains remaining encoded data slices of the decode threshold number of encoded data slices for each of the sets of encoded data slices from one or more other DST execution units (e.g., DST execution units 3 and 5). The obtaining includes issuing one or more further read requests 91 to an identified second subset of DST execution units and receiving further read responses 88.

When the decode threshold number of encoded data slices for each of the sets of encoded data slices have been received, the DST processing unit 96 for each set of encoded data slices, dispersed storage error decodes the decode threshold number of encoded data slices to reproduce a data segment corresponding to the set of encoded data slices. Having produced a plurality of reproduced data segments, the DST processing unit 96 aggregates the plurality of reproduced data segments to produce a recovered data object 97.

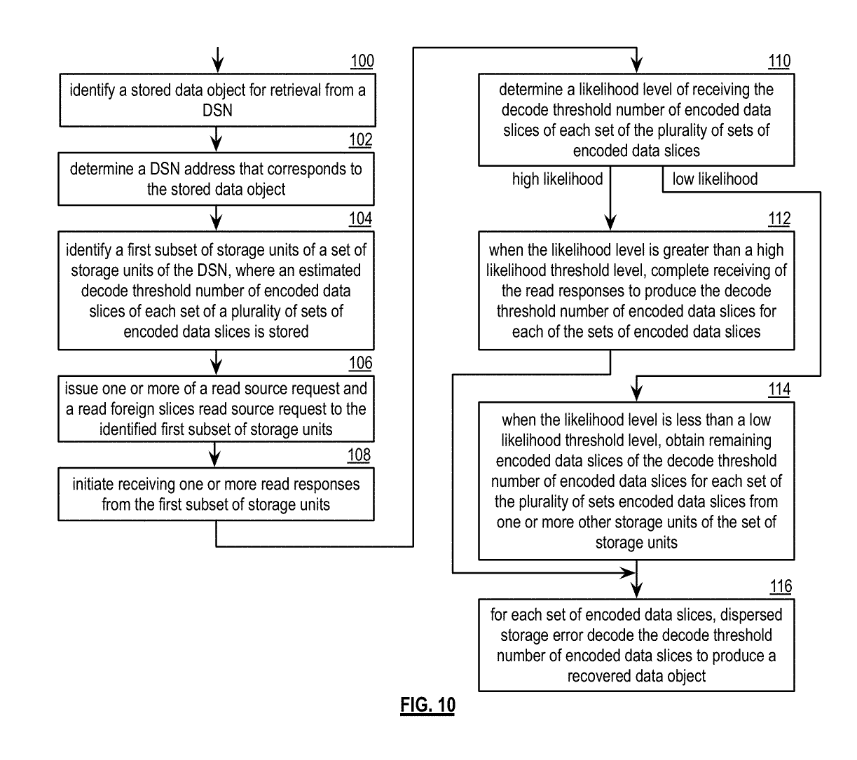

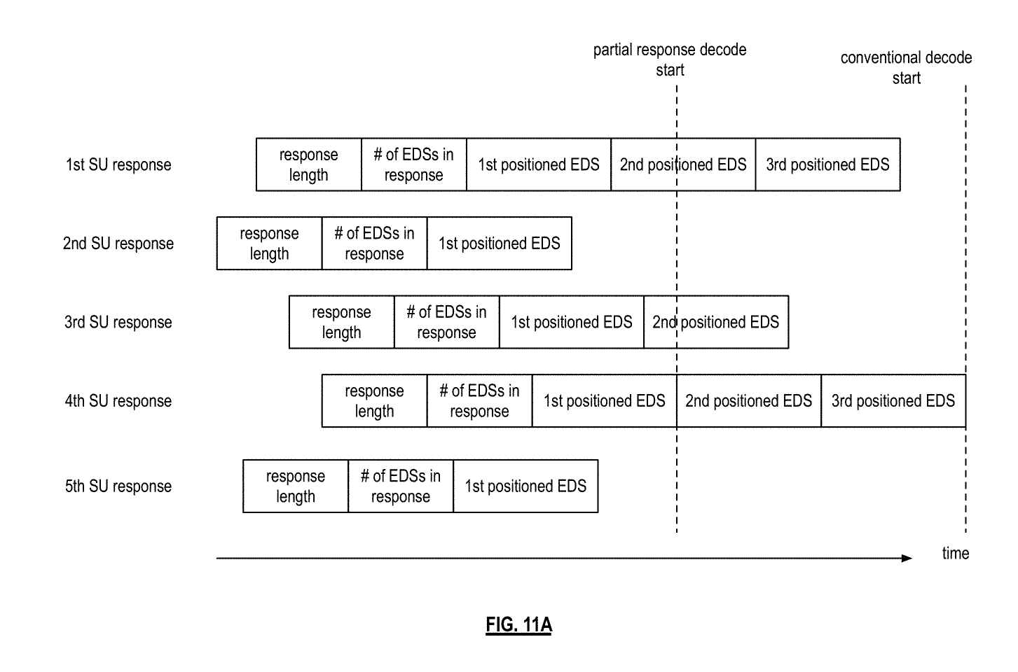

FIG. 10 is a flowchart illustrating another example of recovering data. The method begins or continues with step 100, where a processing module (e.g., of a distributed storage and task (DST) processing unit) identifies a store data object for retrieval from a dispersed storage network (DSN). The method continues with step 102, where the processing module determines a DSN address that corresponds to the stored data object.

The method continues at step 104, where the processing module identifies a first subset of storage units of a set of storage units of the DSN, where an estimated decode threshold number of encoded data slices of each set of a plurality of sets of encoded data slices is stored. The identifying includes at least one of performing a lookup, initiating a query, and interpreting a query response. The method continues at step 106, where the processing module issues one or more of a read source request and a read foreign slices read source request to the identified first subset of storage units. For example, the processing module generates requests based on estimated encoded data slices stored at each storage unit and sends the requests to the first subset of storage units.

The method continues at step 108, where the processing module initiates receiving one or more read responses from the first subset of storage units. The initiating includes receiving bytes of the stream that includes the read response and identifying a first portion of the received stream that includes a read response header, where the read response header indicates one or more of a number of encoded data slices and slice names of the encoded data slices included in the read response.

The method continues at step 110, where the processing module determines a likelihood level of receiving the decode threshold number of encoded data slices of each set of the plurality of sets of encoded data slices. The determining includes interpreting each response to estimate which encoded data slices should be received when the receiving has been completed. The method branches to step 114, where the processing module obtains remaining encoded data slices when the processing module determines that the likelihood level is low. The method continues to the step 112 when the processing module determines that the likelihood level is high.

When the likelihood level is greater than a high likelihood threshold level, the method continues at the step 112, where the processing module completes receiving of the read responses to produce the decode threshold number of encoded data slices for each of the sets of encoded data slices. The completing includes comparing the likelihood level to the high threshold level, and indicating a high likelihood of receiving the decode threshold number of encoded data slices when the likelihood level is greater than the high likelihood that threshold level. The completing further includes continuing to receive read response streams. When the receiving has completed, the method branches to step 116, where the processing module decodes the encoded data slices.

When the likelihood level is less than a low likelihood threshold level, the method continues at step 114, where the processing module obtains remaining encoded data slices of the decode threshold number of encoded data slices for each set of the plurality of sets of encoded data slices from one or more other storage units of the set of storage units. The obtaining includes identifying a second subset of storage units likely to include desired encoded data slices, issuing one or more further read requests, receiving additional read responses, and extracting further encoded data slices. Alternatively, or in addition to, the processing module performs a similar process in a recursive manner.

The method continues with step 116, where, for each set of encoded data slices, the processing module dispersed storage error decodes the decode threshold number of encoded data slices for each set of encoded data slices to produce a recovered data object.

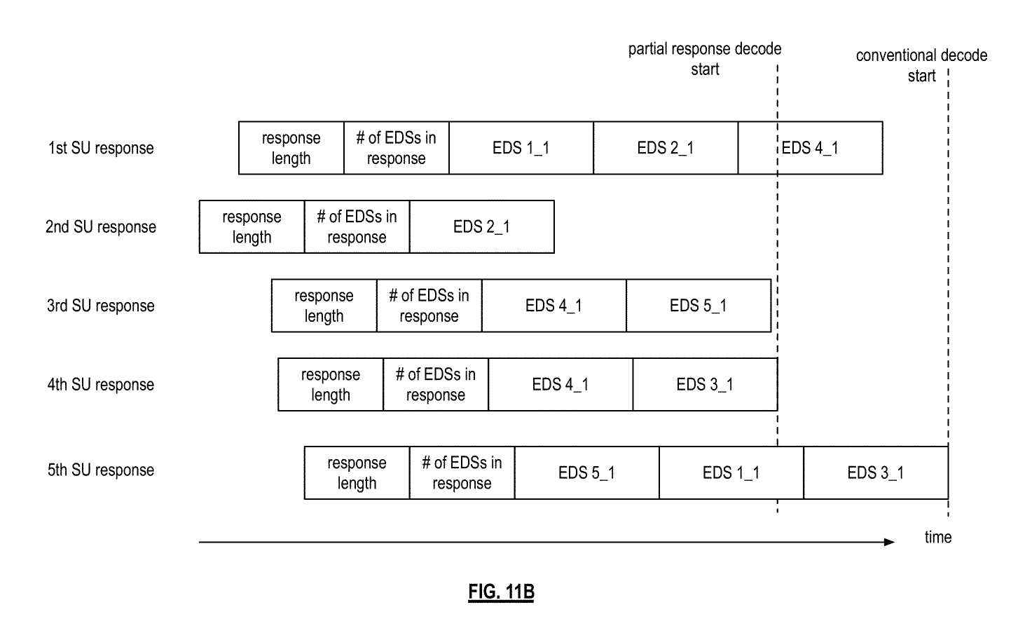

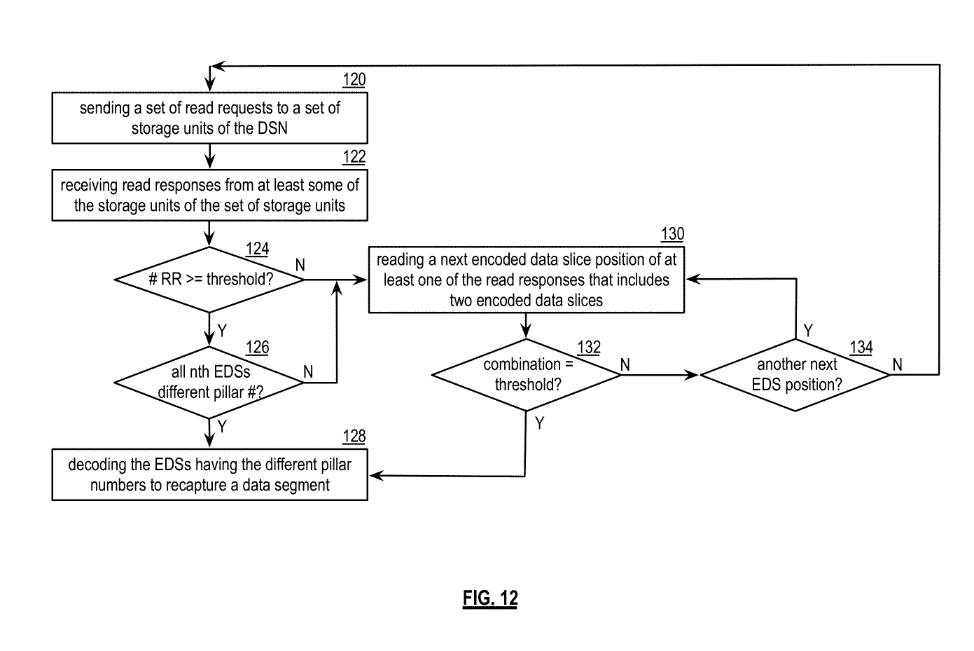

FIG. 11A is a schematic block diagram of an example of a method of partial response decoding in a dispersed storage network (DSN). In this example, a computing device (e.g., the DS processing unit 96 of FIG. 9A, the computing device 12-16 of FIG. 1, etc.) receives read responses from a set of storage units in the DSN. Also in this example, the computing device receives read responses from five (e.g., a decode threshold number) storage units of the set of storage units. Each read response includes a header and one or more positioned encoded data slices. In this example, each first positioned encoded data slice is of a different pillar number than other positioned encoded data slices. The header includes a response length field and a number of encoded data slices (EDSs) in response field. For example, the first header may indicate the response length is 1200 kilobytes (KB) and the number of encoded data slices in the read response is 3. The computing device may then determine the estimated size of the of first positioned encoded data slice to be 400 KB (e.g., 1200/3). As another example, the second header (e.g., from the second storage unit) indicates the response length is 400 kilobytes (KB) and the number of encoded data slices in the read response is 1. Alternatively, the header may not include the number of encoded data slices in response field and the computing device may determine an estimated number of encoded data slices in the read response based on the response length and a known encoded data slice size for the data segment (e.g., based on certain dispersed storage data parameters). For example, when the response length is 1200 kilobytes (KB) and the encoded data slice size is 400 KB, the computing device determines that an estimated 3 (e.g., 1200/400) encoded data slices are included in the read response.

Continuing with the example, the computing device interprets the headers to determine when a decode threshold number of first positioned encoded data slices will be received. For example, when the decode threshold number of first positioned encoded data slices are received and when each of the first positioned encoded data slices are of a different pillar number, the computing device may begin to decode the first positioned encoded data slices to recover a first data segment. For example, at the time when the computing device has received 400 KB in the read response (e.g., after the header bytes) from the fourth storage unit, the computing device determines to begin decoding (e.g., start a partial response decoding process) a first data segment corresponding to the received decode threshold number of differing pillar number first positioned encoded data slices. In a conventional decoding process, a computing device may wait to begin a decoding process until all read responses have been received. For example, the computing device would start the decoding when the third positioned encoded data slices from the fourth storage unit has been received. In this example, using the conventional decode start would require reading 800 KB more data in the fourth read response before commencing a decoding process.

FIG. 11B is another schematic block diagram of an example of a method of partial response decoding in a dispersed storage network (DSN). In this example, the computing device does not receive a decode threshold number (e.g., 5) of encoded data slices corresponding to a first data segment after receiving all the first positioned encoded data slices (e.g., EDS 1_1, EDS 2_1, EDS 4_1, EDS 4_1, and EDS 5_1). Having determined the first encoded data slice position of each of the decode threshold number of read responses does not include encoded data slices having different pillar numbers, the computing device reads a second encoded data slice position (e.g., EDS 2_1 from SU #1, EDS 5_1 from SU #3, EDS 3_1 from SU #4, and EDS 1_1 from SU #5) of the at least one of the read responses that includes two encoded data slices. For example, the computing device reads the second encoded data slice position in the read response from the fourth storage unit (e.g., EDS 3_1). Having read EDS 3_1, the computing device determines it has received a decode threshold number of encoded data slices having differing pillar numbers (e.g., EDS 1_1, EDS 2_1, EDS 3_1, EDS 4_1, and EDS 5_1). Having received a decode threshold number of encoded data slices having differing pillar numbers, and while receiving additional data in the read responses, the computing device begins partial response decoding the decode threshold number of encoded data slices to produce a first data segment.

FIG. 12 is a flowchart illustrating an example of a method of partial response decoding to recapture data. The method begins with step 120, where a computing device of a dispersed storage network (DSN) sends a set of read requests to a set of storage units of the DSN regarding a set of encoded data slices. The sending the set of read requests includes one or more of sending read source requests to at least some storage units of the set of storage units and sending one or more read foreign requests to one or more of storage units of the set of storage units. The read source request is regarding a particular encoded data slice and is targeted to a particular storage unit. The particular encoded data slice has a particular pillar number and a source name which is included in a DSN address for the particular encoded data slice. The particular storage unit is allocated a DSN address range in which the DSN address of the particular encoded data slice lies. A read foreign request includes a request to read a second particular encoded data slice having the source name but having a pillar number that creates a DSN address outside of the DSN address range of a second particular storage unit.

The method continues with step 122, where the computing device receives read responses from at least some of the storage units of the set of storage units, where at least one of the read responses includes two encoded data slices of the set of encoded data slices. As the read responses are being received and prior to receiving the read responses in full, the method continues at step 124, where the computing device determines whether a decode threshold number of read responses have been received. When the decode threshold number of read responses have not been received, the method branches to step 130.

When the decode threshold number of read responses have been received, the method continues to step 126, where the computing device determines whether a first encoded data slice position of each of the decode threshold number of read responses includes encoded data slices having different pillar numbers. When the first encoded data slice position of each of the decode threshold number of read responses includes the encoded data slices having different pillar numbers, the method continues to step 128, where the computing device decodes the encoded data slices having different pillar numbers to recapture a data segment of a data object. When the first encoded data slice position of each of the decode threshold number of read responses does not include the encoded data slices having different pillar numbers, the method branches to step 130.

The method continues at step 130, where the computing device reads a next (e.g., second, third, etc.) encoded data slice position of the at least one of the read responses that includes two encoded data slices. The method then continues to step 132, where the computing device determines whether a combination of differing pillar numbered encoded data slices that have been read equals the decode threshold number. When the combination of differing pillar numbered encoded data slices that have been read equals the decode threshold number, the method continues to step 128, where the computing device decodes the encoded data slices.

When the combination of differing pillar numbered encoded data slices that have been read equals the decode threshold number, the method branches to step 134, where the computing device determines whether another next encoded data slice position can be read (e.g., by interpreting the read response headers). When another next encoded data slice position can be read, the method loops back to step 130, where the computing device reads a next encoded data slice position. When another next encoded data slice position cannot be read, the method may loop back to step 120, where the computing device sends another read request to the set of storage units for at least one more encoded data slice of the set of encoded data slices. For example, when the received read responses have been read in full and less than a decode threshold number of encoded data slices have been received, the computing device may issue another read request to another storage unit of the DSN for at least one more encoded data slice of the set of encoded data slices.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
sending, by a computing device of a dispersed storage network (DSN), a set of read requests to a set of storage units of the DSN regarding a set of encoded data slices;
receiving, by the computing device, read responses from at least some storage units of the set of storage units, wherein at least one of the read responses includes two encoded data slices of the set of encoded data slices;
as the read responses are being received and prior to receiving the read responses in full:
determining, by the computing device, whether a decode threshold number of read responses have been received;
when the decode threshold number of read responses have been received, determining, by the computing device, whether a first encoded data slice position of each of the decode threshold number of read responses includes encoded data slices having different pillar numbers; and
when the first encoded data slice position of each of the decode threshold number of read responses includes the encoded data slices having different pillar numbers, decoding, by the computing device, the encoded data slices having different pillar numbers to recapture a data segment of a data object.

2. The method of claim 1 further comprises:
when the first encoded data slice position of each of the decode threshold number of read responses does not includes encoded data slices having different pillar numbers, reading, by the computing device, a second encoded data slice position of the at least one of the read responses that includes two encoded data slices; and
when a combination of differing pillar numbered encoded data slices that have been read equals the decode threshold number, decoding, by the computing device, the combination of differing pillar numbered encoded data slices to recover the data segment, wherein the combination of differing pillar numbered encoded data slices includes an encoded data slice read from the second encoded data slice position of the at least one of the read responses that includes two encoded data slices.

3. The method of claim 1 further comprises:
when the decode threshold number of read responses have not been received, reading, by the computing device, a second encoded data slice position of the at least one of the read responses that includes two encoded data slices; and
when a combination of differing pillar numbered encoded data slices that have been read equals the decode threshold number, decoding, by the computing device, the combination of differing pillar numbered encoded data slices to recover the data segment, wherein the combination of differing pillar numbered encoded data slices includes an encoded data slice read from the second encoded data slice position of the at least one of the read responses that includes two encoded data slices.

4. The method of claim 1, wherein the sending the set of read requests comprises one or more of:
sending read source requests to at least some storage units of the set of storage units; and
sending one or more read foreign requests to one or more of storage units of the set of storage units, wherein a read source request of the read source requests is regarding a particular encoded data slice of the set of encoded data slices and is targeted to a particular storage unit of the at least some storage units, wherein the particular encoded data slice has a particular pillar number and a source name, wherein a DSN address for the particular encoded data slice includes the particular pillar number and the source name, wherein the particular storage unit is allocated a DSN address range in which the DSN address of the particular encoded data slice lies, and wherein a read foreign request of the one or more read foreign requests includes a request to read a second particular encoded data slice having the source name and having a pillar number that creates a DSN address that is outside of the DSN address range of a second particular storage unit of the at least some storage units.

5. The method of claim 4, wherein the source name comprises one or more of:
a vault identifier;
a data object identifier;
a generation level; and
a revision level.

6. The method of claim 1 further comprises:
when the received read responses have been read in full and less than a decode threshold number of encoded data slices have been received, issuing, by the computing device, another read request to another storage unit of the DSN for at least one more encoded data slice of the set of encoded data slices.

7. A computing device of a dispersed storage network (DSN) comprises:
memory;
an interface; and
a processing module operably coupled to the memory and the interface, wherein the processing module is operable to:
send, via the interface, a set of read requests to a set of storage units of the DSN regarding a set of encoded data slices;
receive, via the interface, read responses from at least some storage units of the set of storage units, wherein at least one of the read responses includes two encoded data slices of the set of encoded data slices;
as the read responses are being received and prior to receiving the read responses in full:
determine whether a decode threshold number of read responses have been received;
when the decode threshold number of read responses have been received, determine whether a first encoded data slice position of each of the decode threshold number of read responses includes encoded data slices having different pillar numbers; and
when the first encoded data slice position of each of the decode threshold number of read responses includes the encoded data slices having different pillar numbers, decode the encoded data slices having different pillar numbers to recapture a data segment of a data object.

8. The computing device of claim 7, wherein the processing module is further operable to:
when the first encoded data slice position of each of the decode threshold number of read responses does not includes encoded data slices having different pillar numbers, read a second encoded data slice position of the at least one of the read responses that includes two encoded data slices; and
when a combination of differing pillar numbered encoded data slices that have been read equals the decode threshold number, decode the combination of differing pillar numbered encoded data slices to recover the data segment, wherein the combination of differing pillar numbered encoded data slices includes an encoded data slice read from the second encoded data slice position of the at least one of the read responses that includes two encoded data slices.

9. The computing device of claim 7, wherein the processing module is further operable to:
when the decode threshold number of read responses have not been received, read a second encoded data slice position of the at least one of the read responses that includes two encoded data slices; and
when a combination of differing pillar numbered encoded data slices that have been read equals the decode threshold number, decode the combination of differing pillar numbered encoded data slices to recover the data segment, wherein the combination of differing pillar numbered encoded data slices includes an encoded data slice read from the second encoded data slice position of the at least one of the read responses that includes two encoded data slices.

10. The computing device of claim 7, wherein the processing module is operable to send, via the interface, the set of read requests by one or more of:
sending read source requests to at least some storage units of the set of storage units; and
sending one or more read foreign requests to one or more of storage units of the set of storage units, wherein a read source request of the read source requests is regarding a particular encoded data slice of the set of encoded data slices and is targeted to a particular storage unit of the at least some storage units, wherein the particular encoded data slice has a particular pillar number and a source name, wherein a DSN address for the particular encoded data slice includes the particular pillar number and the source name, wherein the particular storage unit is allocated a DSN address range in which the DSN address of the particular encoded data slice lies, and wherein a read foreign request of the one or more read foreign requests includes a request to read a second particular encoded data slice having the source name and having a pillar number that creates a DSN address that is outside of the DSN address range of a second particular storage unit of the at least some storage units.

11. The computing device of claim 10, wherein the processing module is operable to determine the source name by one or more of:
determining a vault identifier;
determining a data object identifier;
determining a generation level; and
determining a revision level.

12. The computing device of claim 7, wherein the processing module is further operable to:
when the received read responses have been read in full and less than a decode threshold number of encoded data slices have been received, issue another read request to another storage unit of the DSN for at least one more encoded data slice of the set of encoded data slices.
